(19) United States
(12) Patent Application Publication
(10) Pub. No.: US 2019/0093719 A1
(43) Pub. Date: Mar. 28, 2019

(54) DISC BRAKES AND BRAKING SYSTEMS

(71) Applicant: AP Racing Limited, Coventry (GB)

(72) Inventors: Christopher David ARROWSMITH, Coventry (GB); Timothy Ian MURDOCH, Coventry (GB); Richard Arnold BASS, Coventry (GB); Bradley ARMITAGE, Coventry (GB)

(21) Appl. No.: 15/746,977

(22) PCT Filed: Jul. 21, 2016
(86) PCT No.: PCT/GB2016/052218

§ 371 Date: Jan. 23, 2018

(30) Foreign Application Priority Data
Jul. 24, 2015 (GB) 1513126.1

(51) Int. Cl. F16D 65/12; F16D 55/225

(52) U.S. Cl. CPC F16D 65/128; F16D 2065/1328; F16D 55/225

(57) ABSTRACT

The invention provides a method of increasing the ventilation in a ventilated disc brake comprising a friction ring 2 and a bell mount 12 defining an internal cavity, by fastening in the cavity an axially inner ventilating structure 200 separate of the friction ring 2 which has vanes 208a, 208b defining channels 209a, 209b aligned with those of the disc brake. The ventilating structure 200 can have a thinner cross section, a lower density, and/or a lower thermal conductivity, than the friction ring 2. The mount additionally or alternatively includes a ventilator comprising vanes 328a, 328b defining channels 329a, 329b arranged to blow air outwardly from the interior of the cavity in a radial direction towards the caliper 4.

This invention relates to a ventilated disc brake and to a braking system including such a brake, particularly but not exclusively for automobiles.

Disc brakes are used in automobiles, motorcycles, bicycles, aeroplanes, trains and other vehicles, or apparatus with moving wheels. They comprise a brake disc (or, more accurately, annulus) rotating with a wheel, and a caliper around the disc mounting one or more pistons which engage the disc when the brake is actuated.

Most racing car brake discs, and many high performance automobile road brake discs, are designed to be mounted on to the hub or stub axle by means of a “Mounting Bell”—a mounting component in the form of a stubby cylinder, cone, dome or bell which defines a concave region or cavity inside the disc. In racing car brakes, the mounting bell is a separate component mounted to the wheel, to which the disc in turn is mounted. Some road vehicle brakes, however, have an integrally cast disc-and-bell assembly for mounting to the wheel.

Racing car discs are subjected to high braking loads, which in turn impose high thermal loads due to the friction acting on the disc. These loads are repeated frequently over the short life of the disc. The temperature of the brake disc of a high-performance road car may reach 800C, and for a racing car, the average temperature can be around 800C with peak temperatures over 1000C. This combination of cyclical thermal and mechanical loads can lead to deformation or cracking, and other disc problems, potentially endangering the user.

Mounting bells for racing cars are usually made from high grade aluminium alloy although other materials can be used. This arrangement is much lighter than a one piece disc and bell, and allows some compliance to reduce the risk of distortion due to heat expansion of the disc. The larger the disc, the more important this becomes.

To mitigate the effects of the imposed thermal loads, some brake discs include ventilating structures. These may comprise a pair of parallel coaxial circular parts or plates, between which are curved cooling vanes, which channel air inwardly of the disc when the wheel is rotating in the forwards direction, to dissipate heat. U.S. Pat. No. 5,810,123, for example, shows such a structure. The amount of cooling that can be directed into the disc is limited by the air gap between the two parallel plates; the number of vanes; and the design of the vanes.

The caliper may also require cooling, and this is usually achieved by providing brake ducting over or integral to the caliper bridge (the portion rigidly connecting the two sides of the caliper disposed on opposite sides of the disc).

The present invention is defined in the independent claims hereafter. Embodiments of the invention improve the ventilation of such a disc brake. In a first aspect, the air mass flow into the disc airgap is increased by the addition of a separate disc vent extension. In a second aspect, the air mass flow onto the outboard portion of the caliper is increased by means of a ventilation structure on the bell mount.

At this point it may be mentioned that some disc brakes do not use a bell mount, but an inner mounting disc, within, coplanar and coaxial with the friction rings of the brake. WO02/090791 (Brembo) illustrates a disc brake of this kind in which a ring of tabs act as vanes to provide an axial airflow into and over the ventilated disc

US2011/0240422 shows a brake of this type in which the mounting disc and the friction rings are interconnected via expansion elements, which are inclined at angles between radial and tangential to the mounting disc. These somewhat thermally decouple the friction rings from the mounting disc so as to reduce the radial temperature profile over the friction rings, and also flex to take up the expansion of the friction rings with temperature. It is also proposed that the expansion elements could act as extensions of the vanes between the friction rings. However, as they are the sole interconnection between the friction rings and the mounting disc they must be relatively heavy to carry the entire braking load, and the channels between them are necessarily closed at their inwards ends by the mounting disc which limits their cooling performance.

Preferred aspects of the invention will be apparent from the description and claims below.

The invention will now be illustrated, by way of example only, with reference to the accompanying drawings in which:

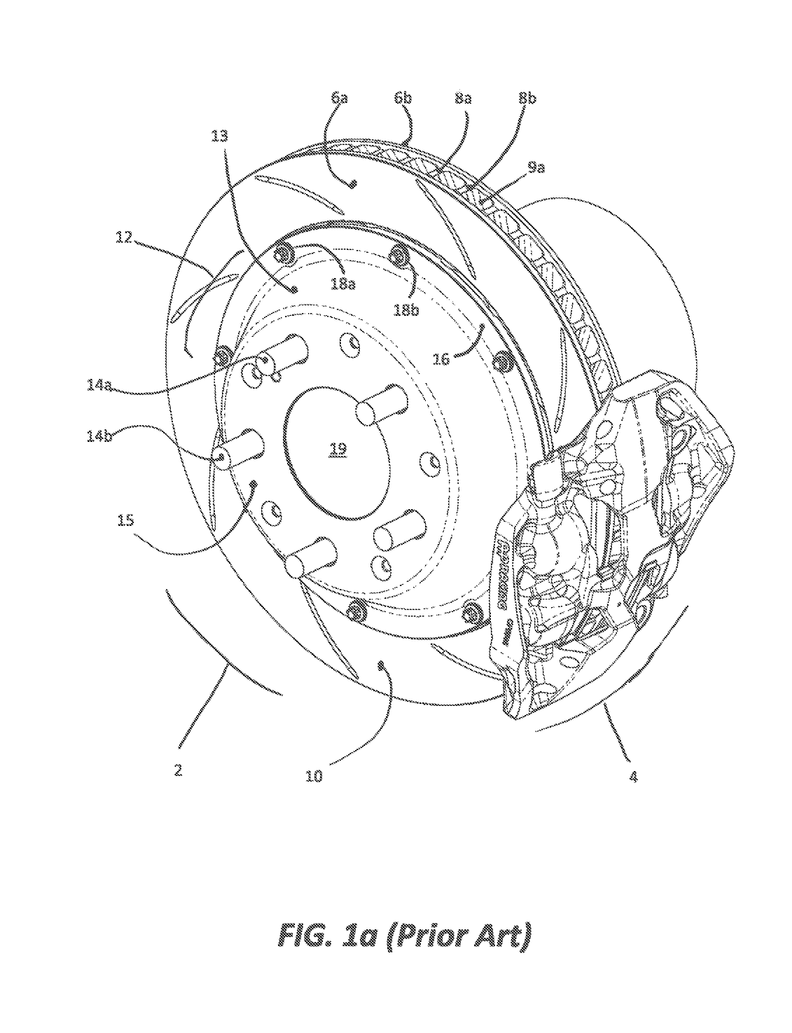

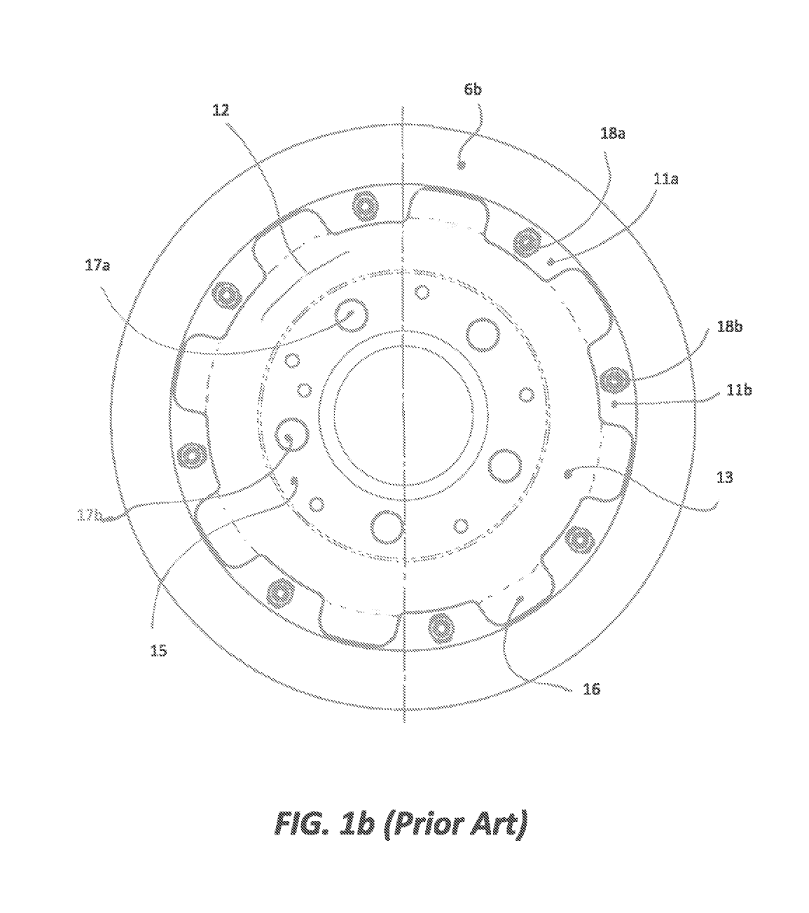

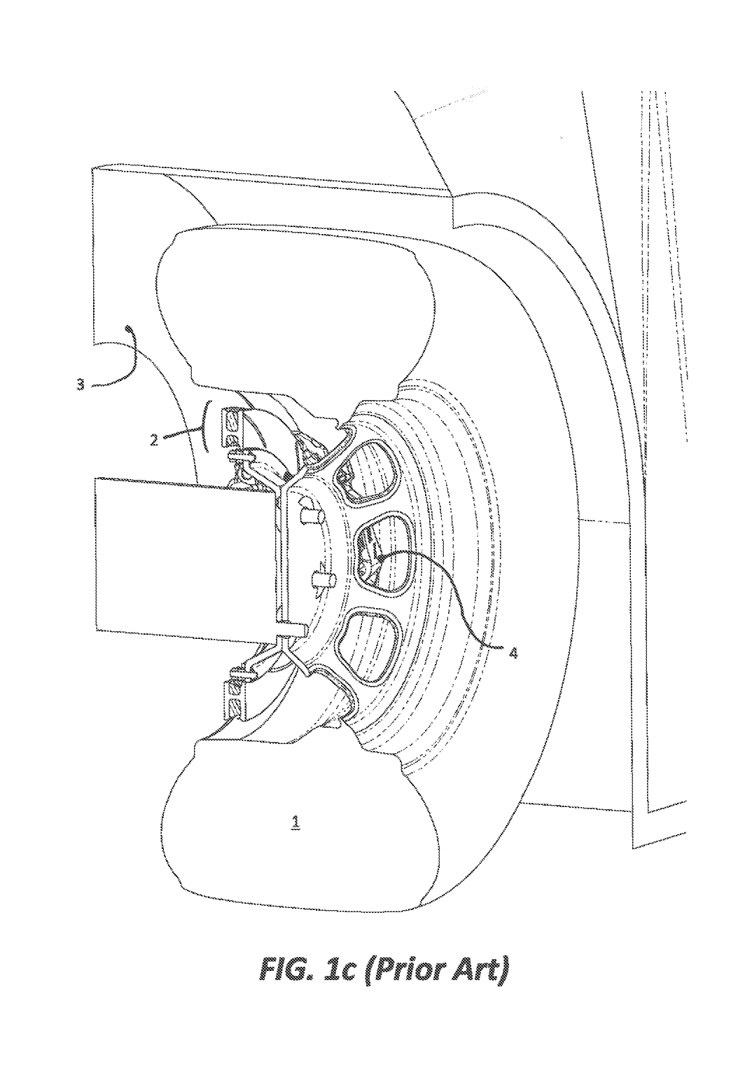

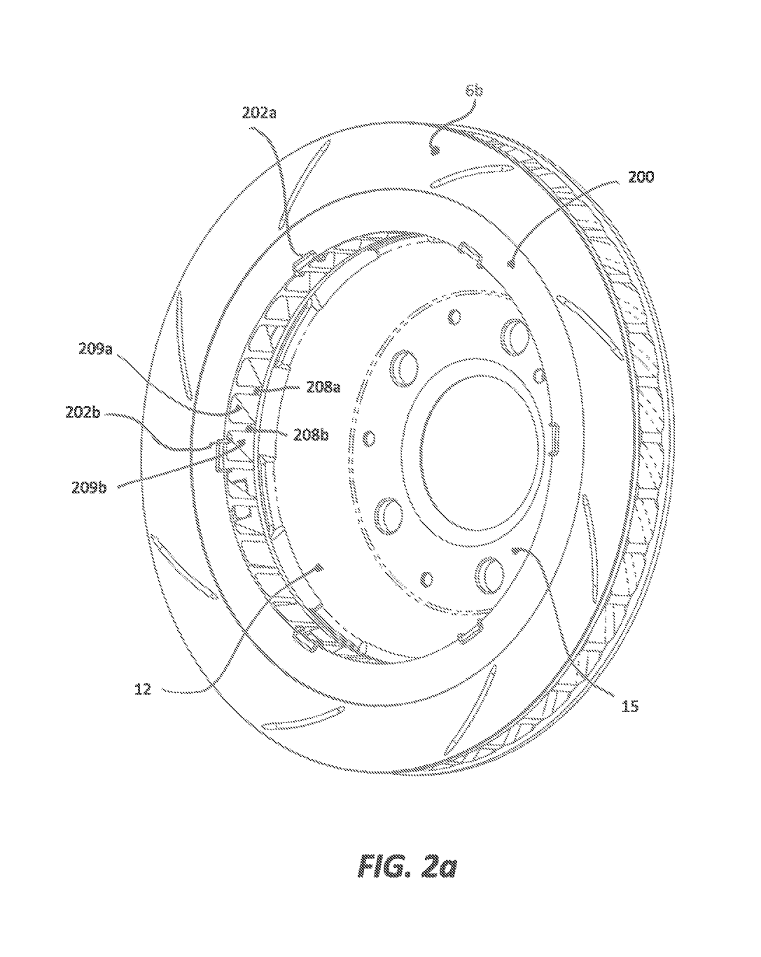

FIG. 1a is a perspective view illustrating a known bell-mounted ventilated disc brake system, the components of which may also be present in embodiments of the invention;

FIG. 1b is a front elevation of the disc thereof, looking into the mounting bell thereof; and

FIG. 1c is a perspective sectional view of that disk looking rearwardly of a car, showing the disc brake in situ mounted to a wheel within the underbody of the car;

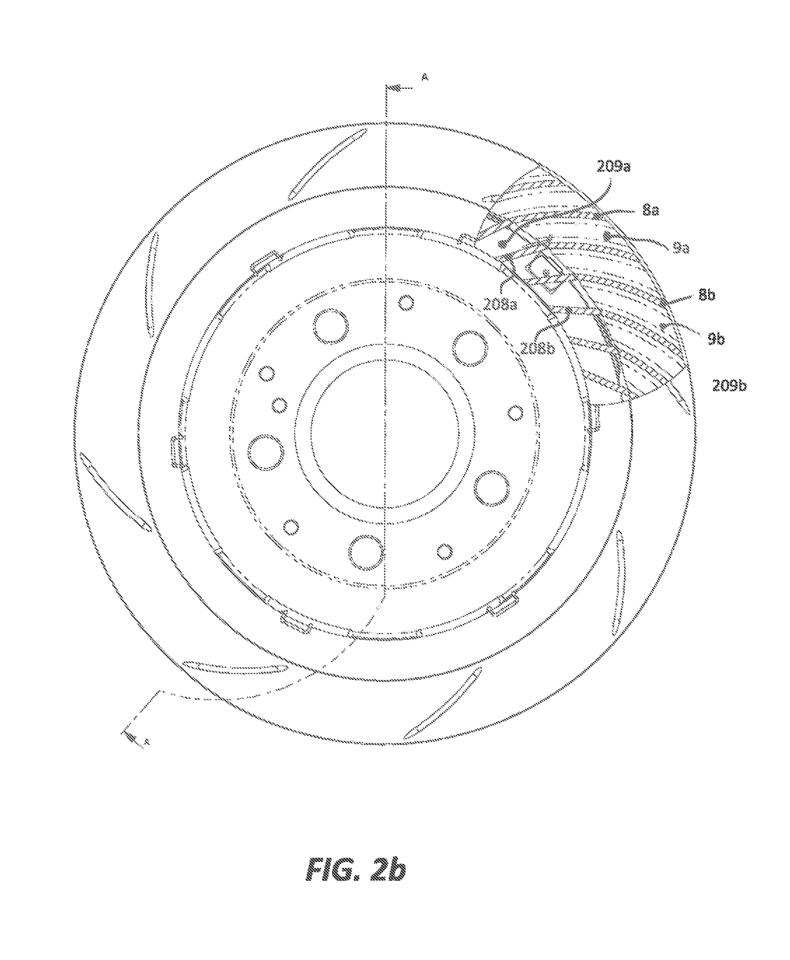

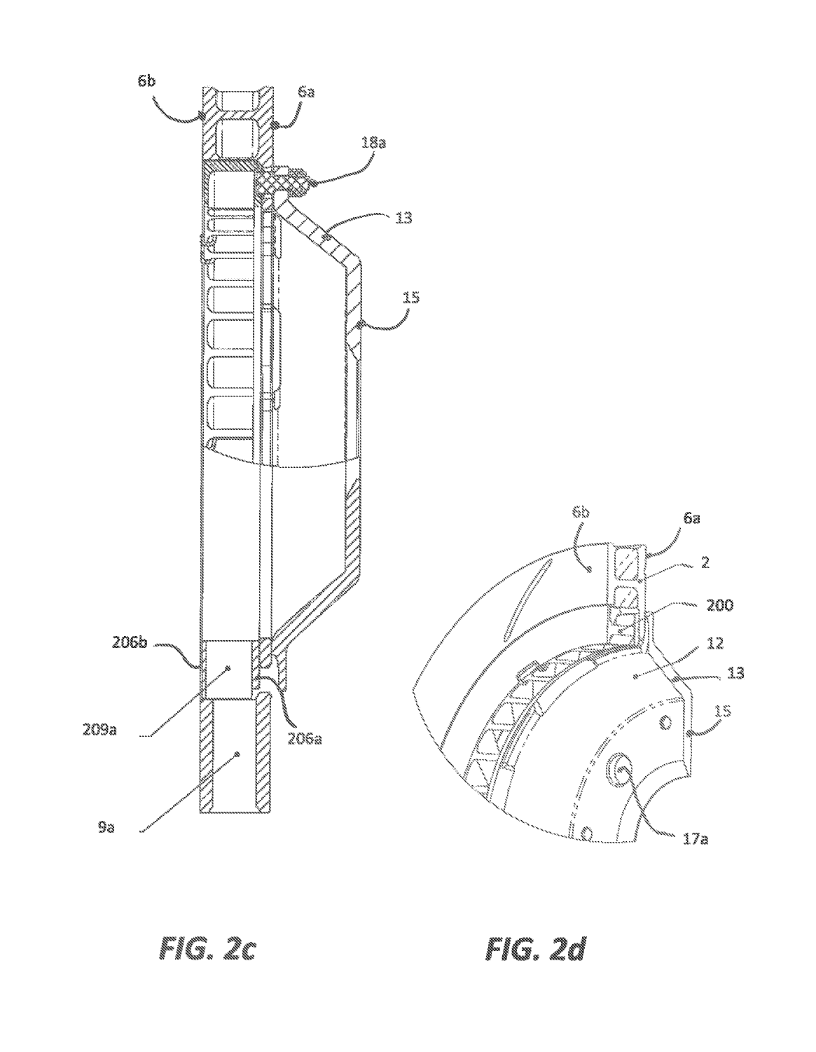

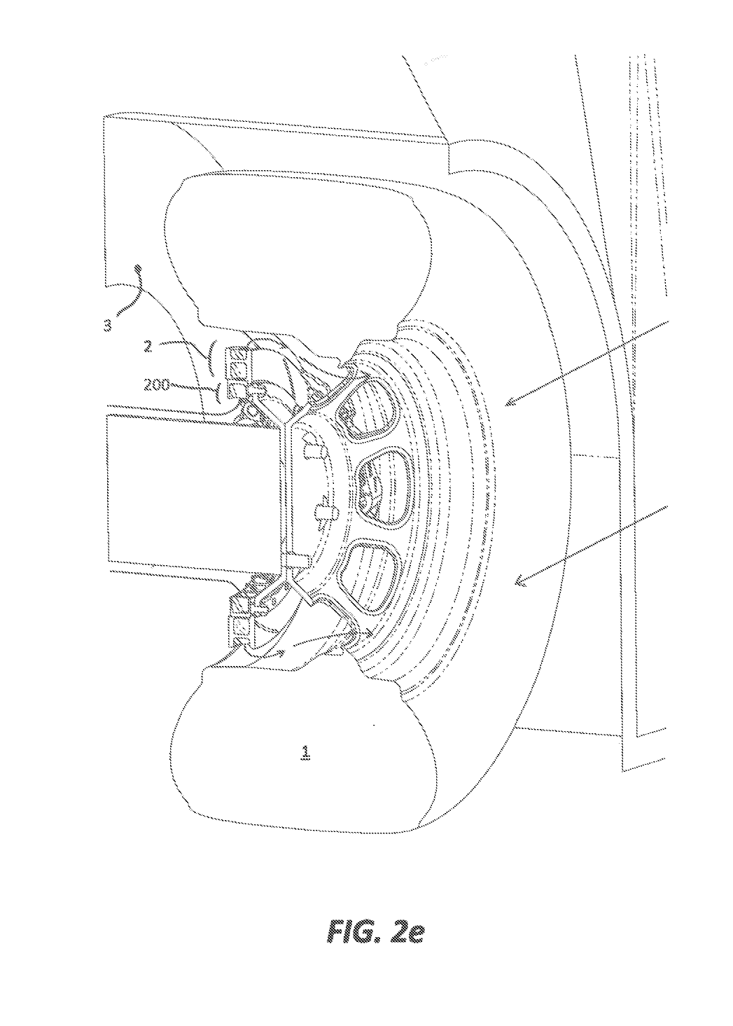

FIG. 2a is a perspective view of the disc-and-bell assembly of a first embodiment;

FIG. 2b is a front elevation of the disc assembly of the first embodiment, looking into the mounting bell thereof;

FIG. 2c is a sectional end elevation of the disc assembly of the first embodiment, along line A-A of FIG. 2b;

FIG. 2d is a partial sectional perspective view of the disc assembly of the first embodiment, along line A-A of FIG. 2b; and

FIG. 2e is a perspective sectional view of the disc assembly of the first embodiment looking rearwardly of a car, showing the disc brake in situ mounted to a wheel within the underbody of the car, with the ventilated airflow shown;

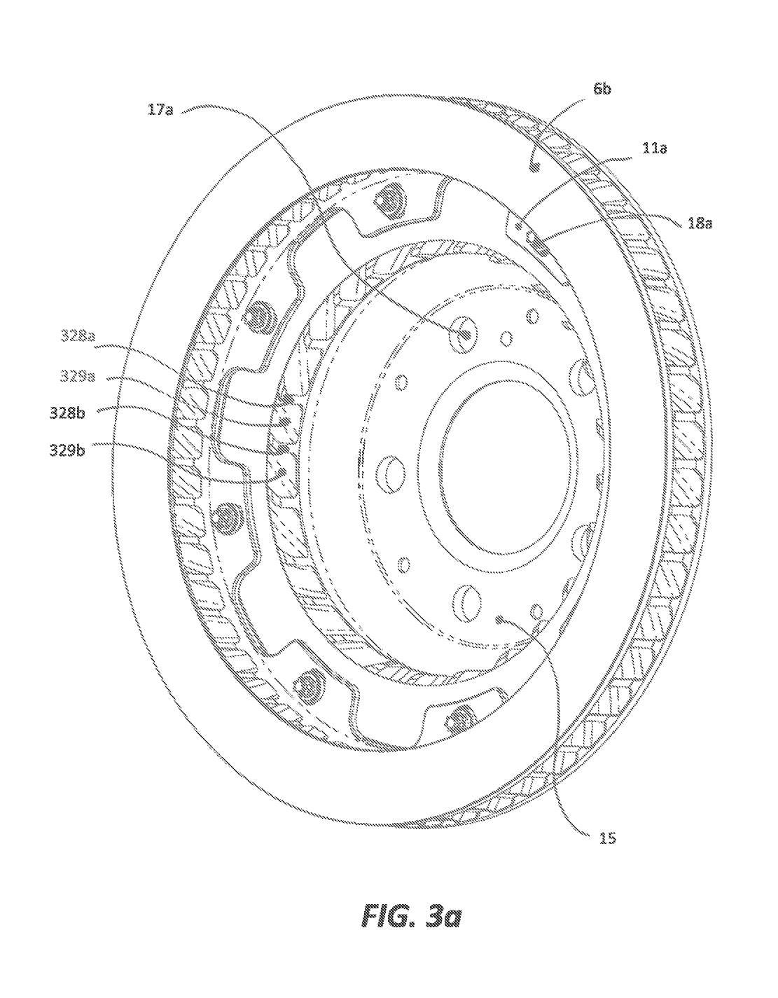

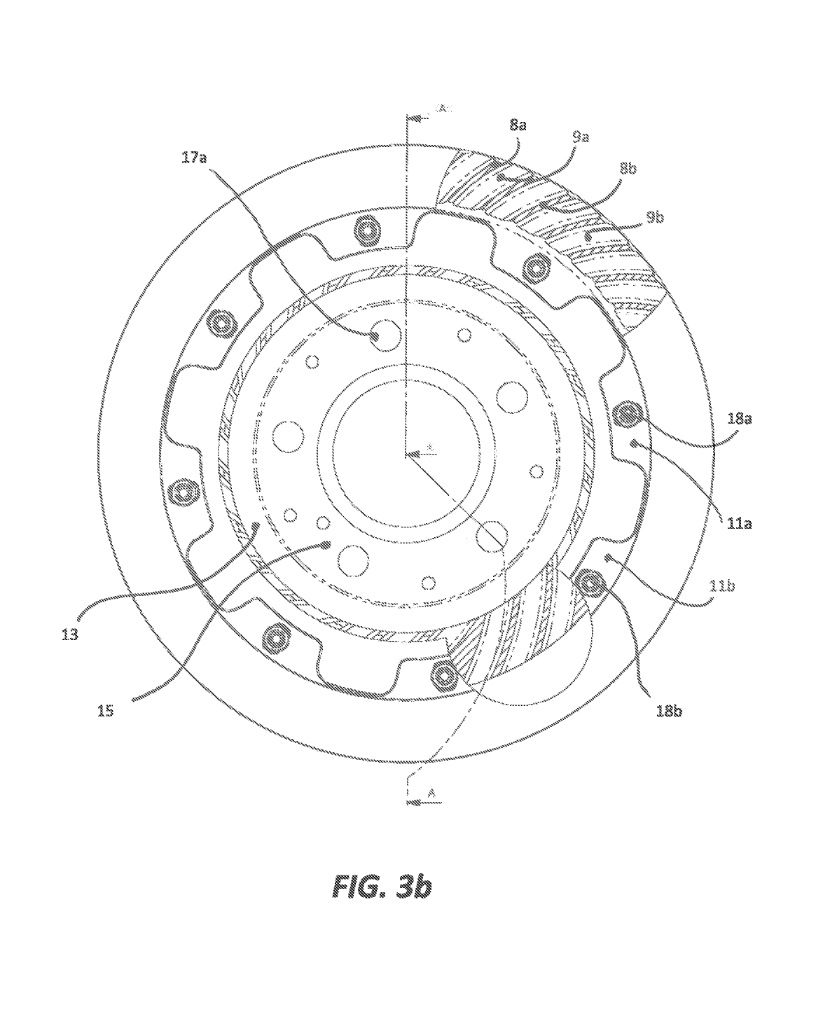

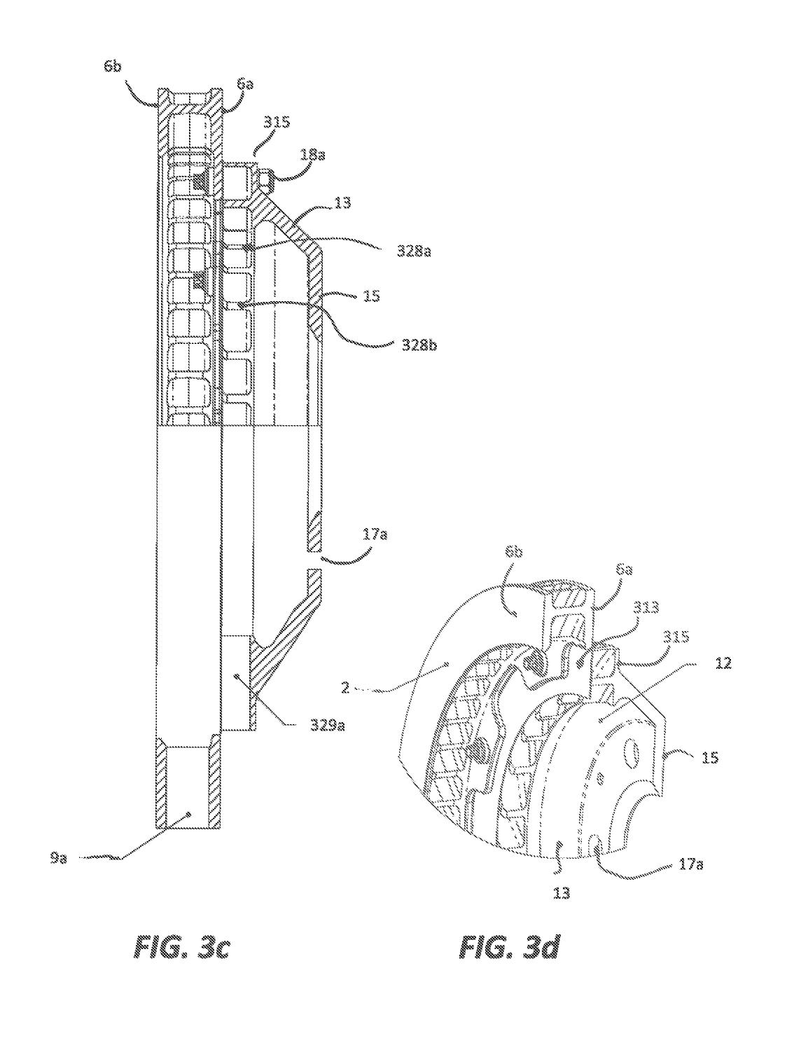

FIG. 3a is a perspective view of the disc assembly of a second embodiment;

FIG. 3b is a front elevation of the disc assembly of the second embodiment, looking into the mounting bell thereof;

FIG. 3c is a sectional end elevation of the disc assembly of the second embodiment, along line A-A of FIG. 3b; and

FIG. 3d is a partial sectional perspective view of the disc assembly of the second embodiment, along line A-A of FIG. 3b;

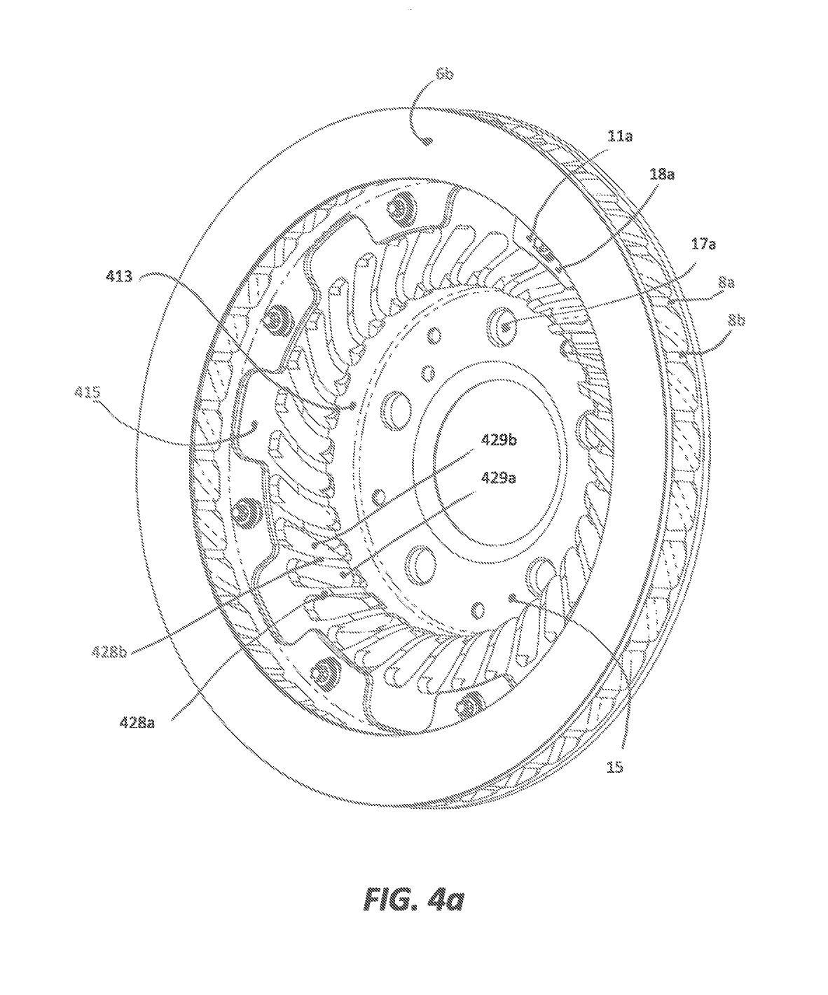

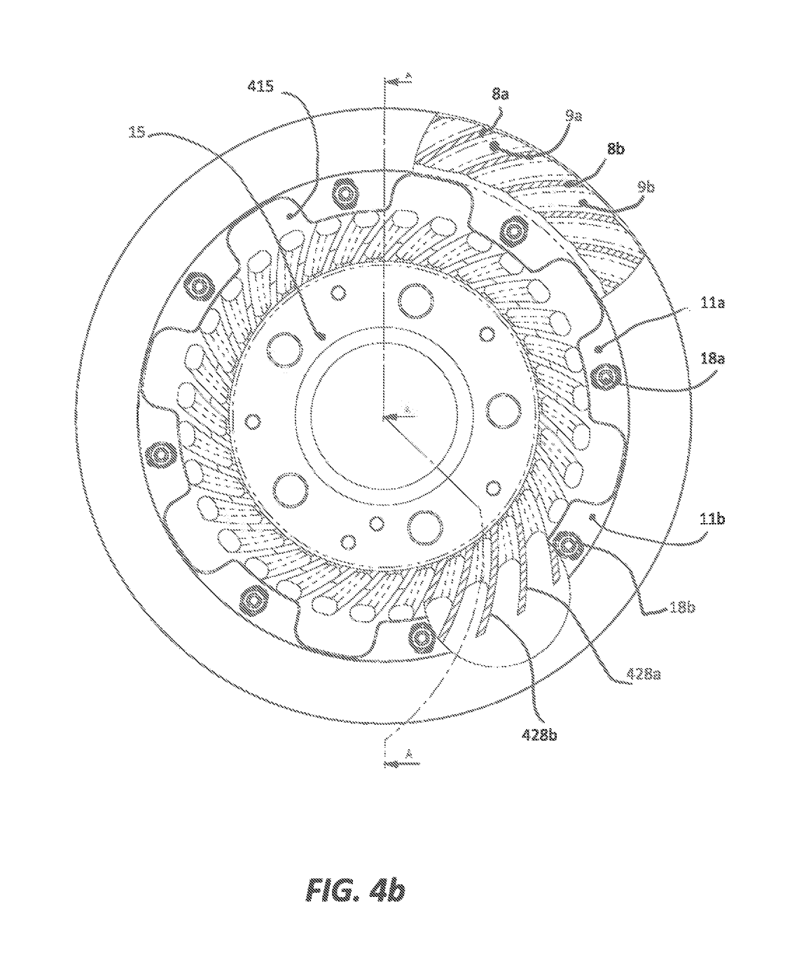

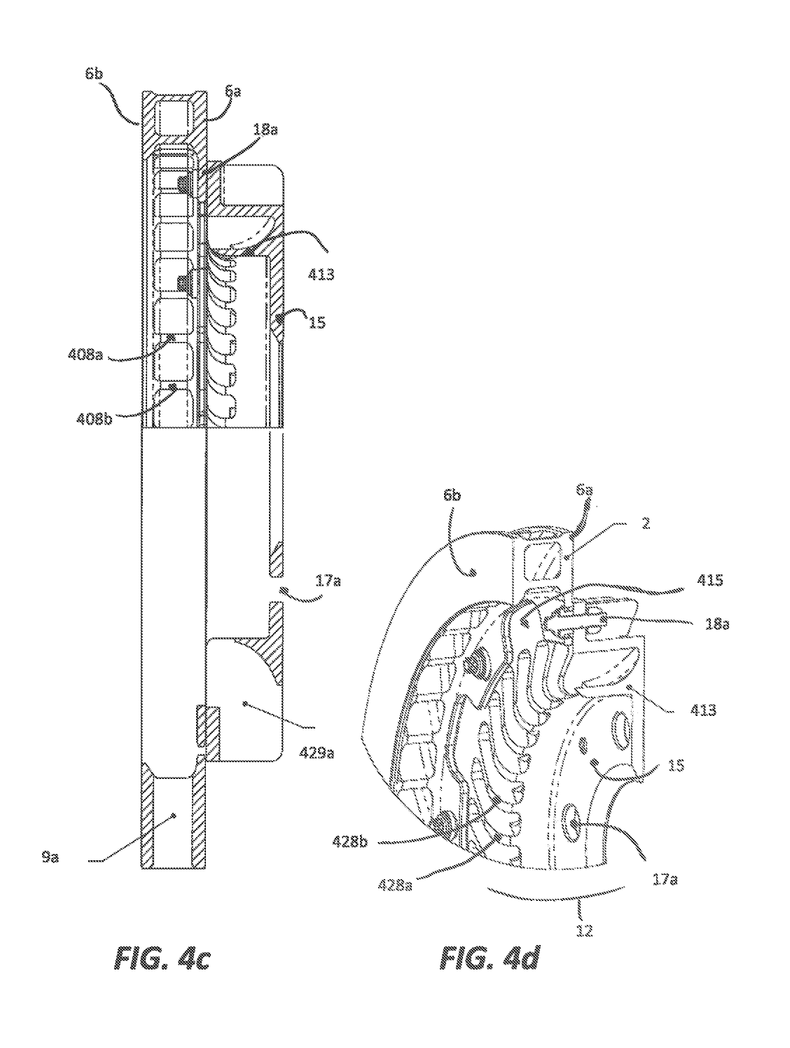

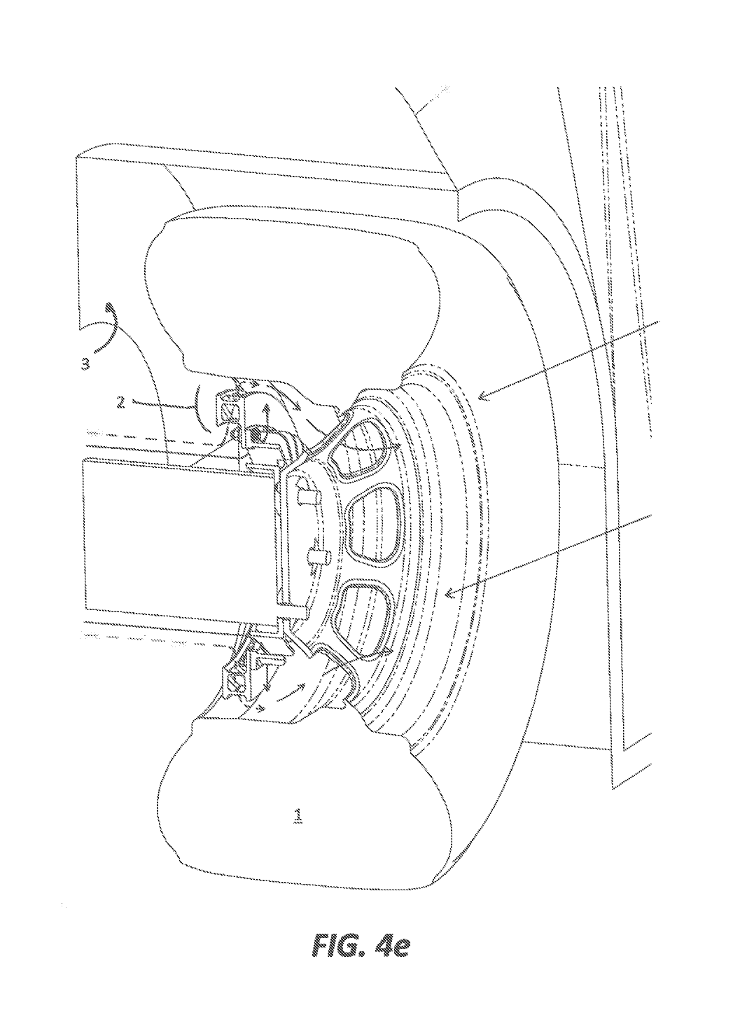

FIG. 4a is a perspective view of the disc assembly of a third embodiment;

FIG. 4b is a front elevation of the disc assembly of the third embodiment, looking into the mounting bell thereof;

FIG. 4c is a sectional end elevation of the disc assembly of the third embodiment, along line A-A of FIG. 4b;

FIG. 4d is a partial sectional perspective view of the disc assembly of the third embodiment, along line A-A of FIG. 4b; and

FIG. 4e is a perspective sectional view of the disc assembly of the third embodiment looking rearwardly of a car, showing the disc brake in situ mounted to a wheel within the underbody of the car, with the ventilated airflow shown;

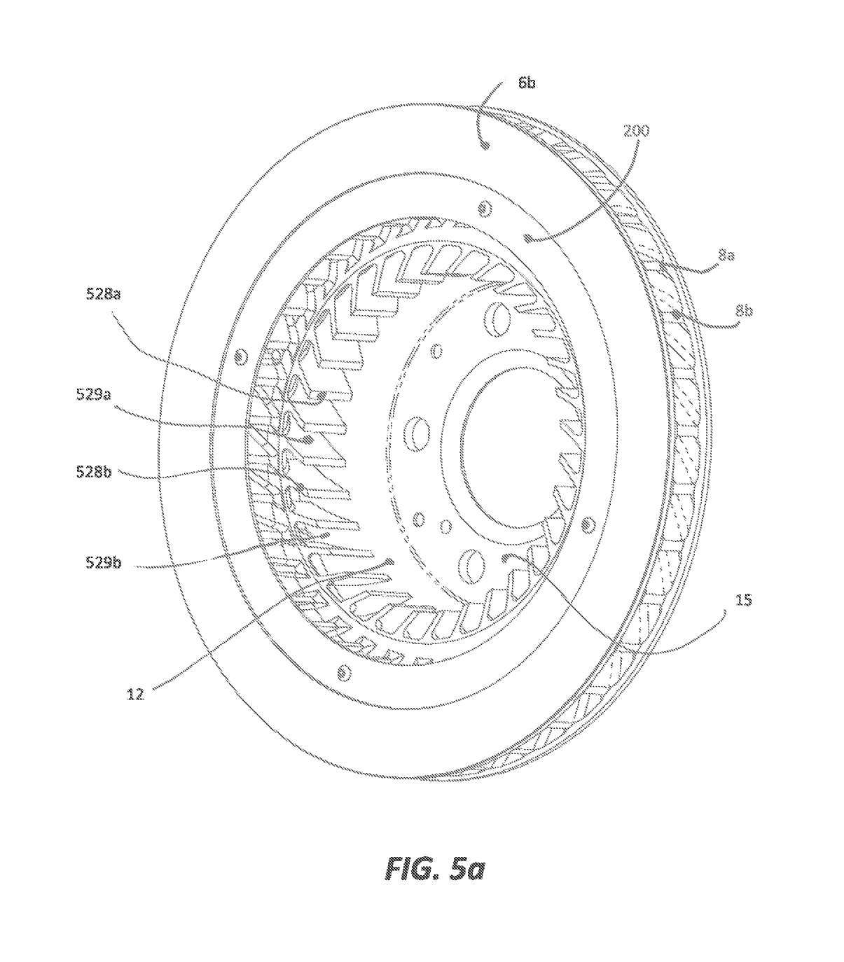

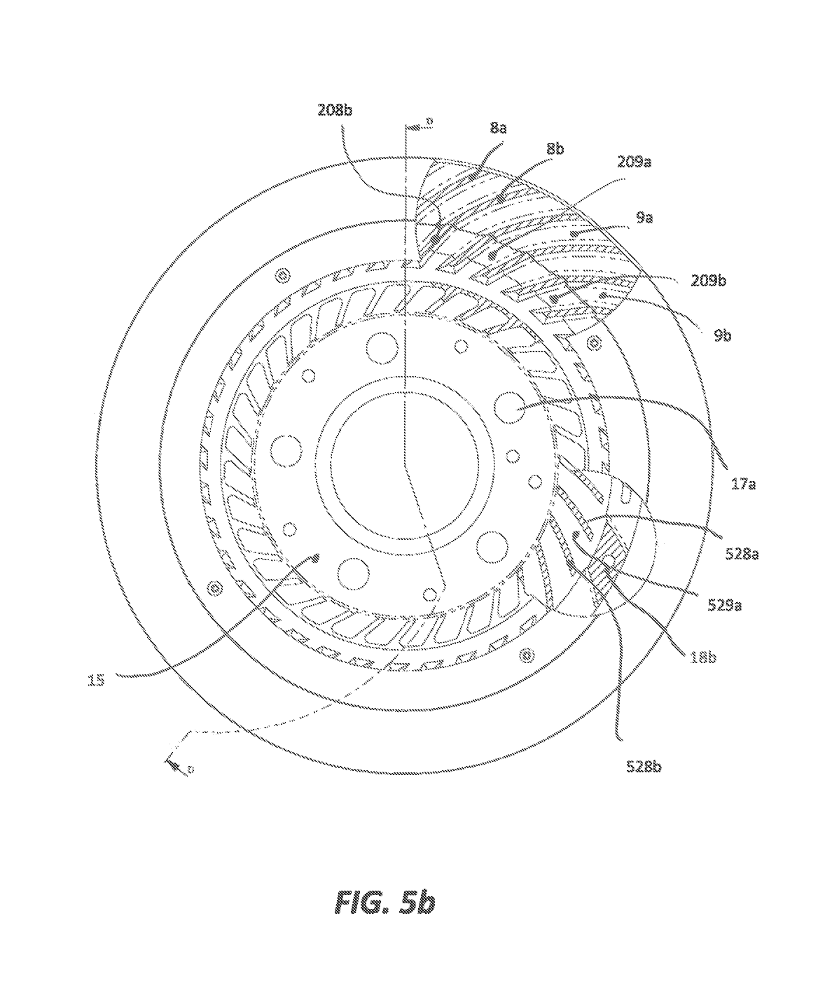

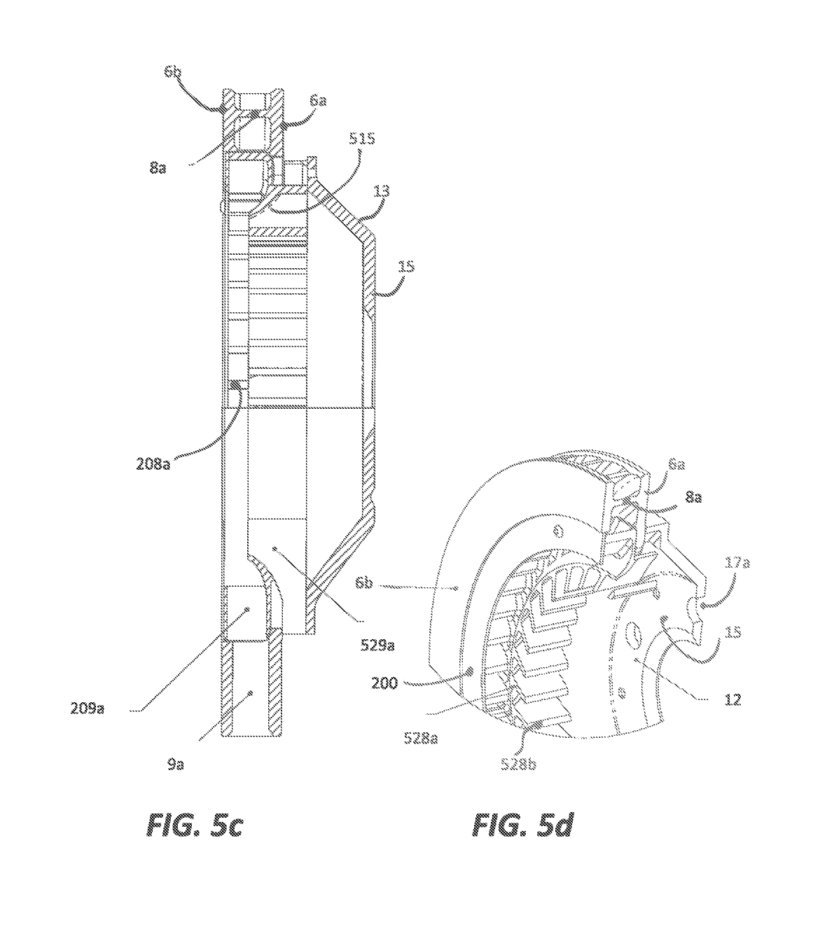

FIG. 5a is a perspective view of the disc assembly of a fourth embodiment;

FIG. 5b is a front elevation of the disc assembly of the fourth embodiment, looking into the mounting bell thereof;

FIG. 5c is a sectional end elevation of the disc assembly of the fourth embodiment, along line D-D of FIG. 5b; and

FIG. 5d is a partial sectional perspective view of the disc assembly of the fourth embodiment, along line D-D of FIG. 5b;

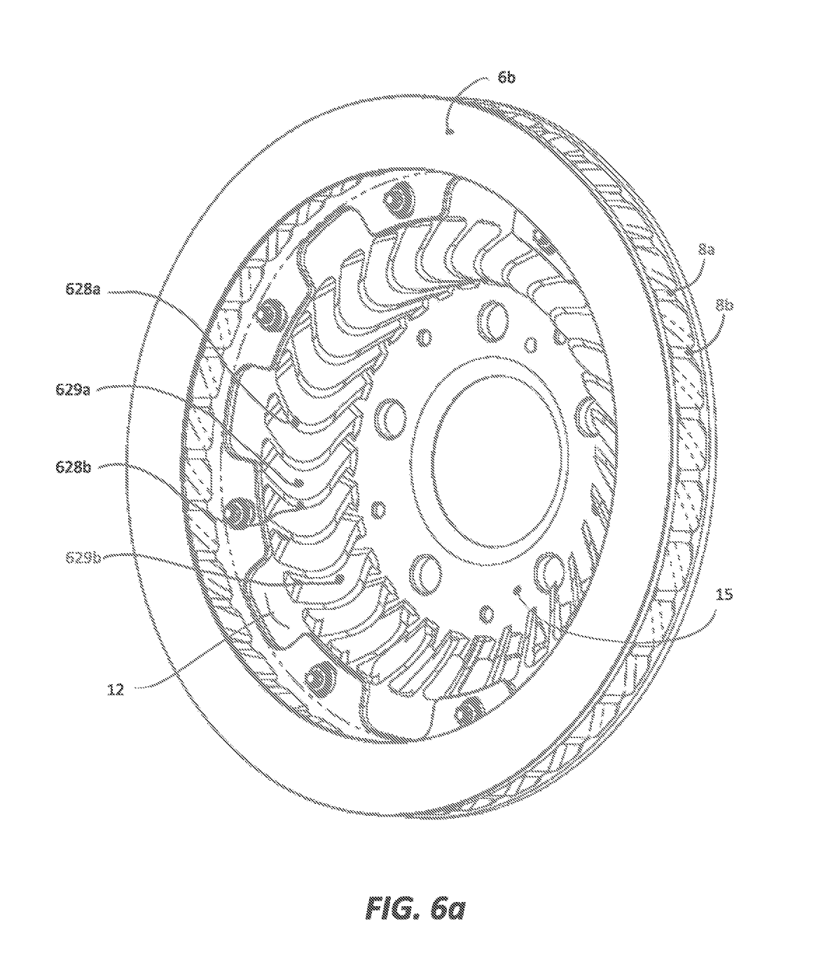

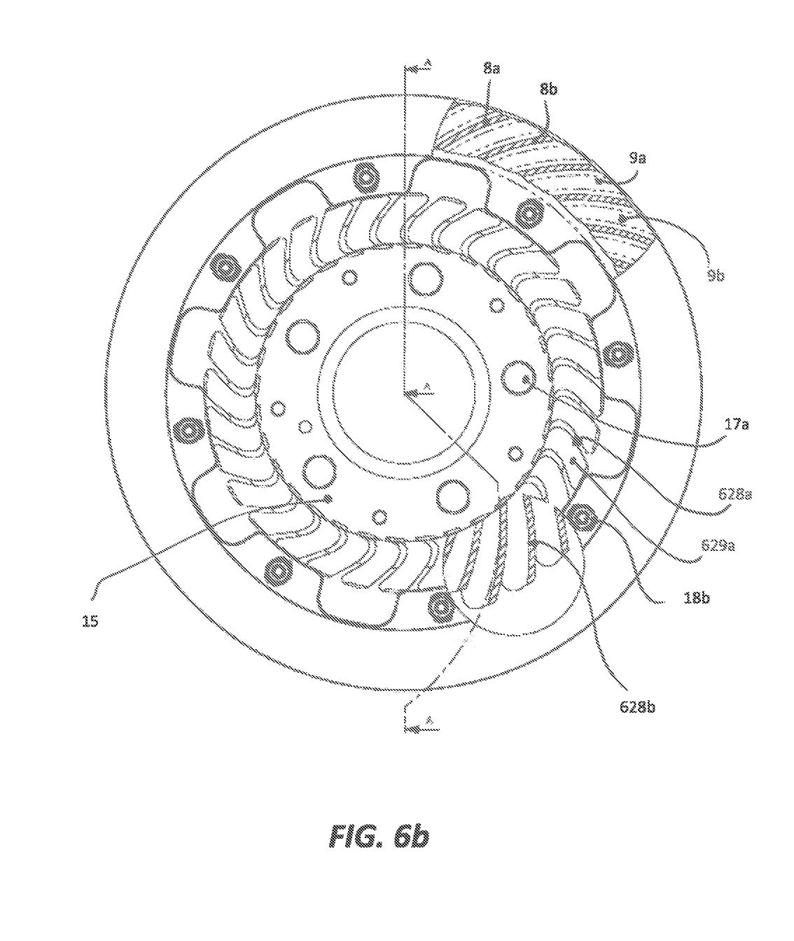

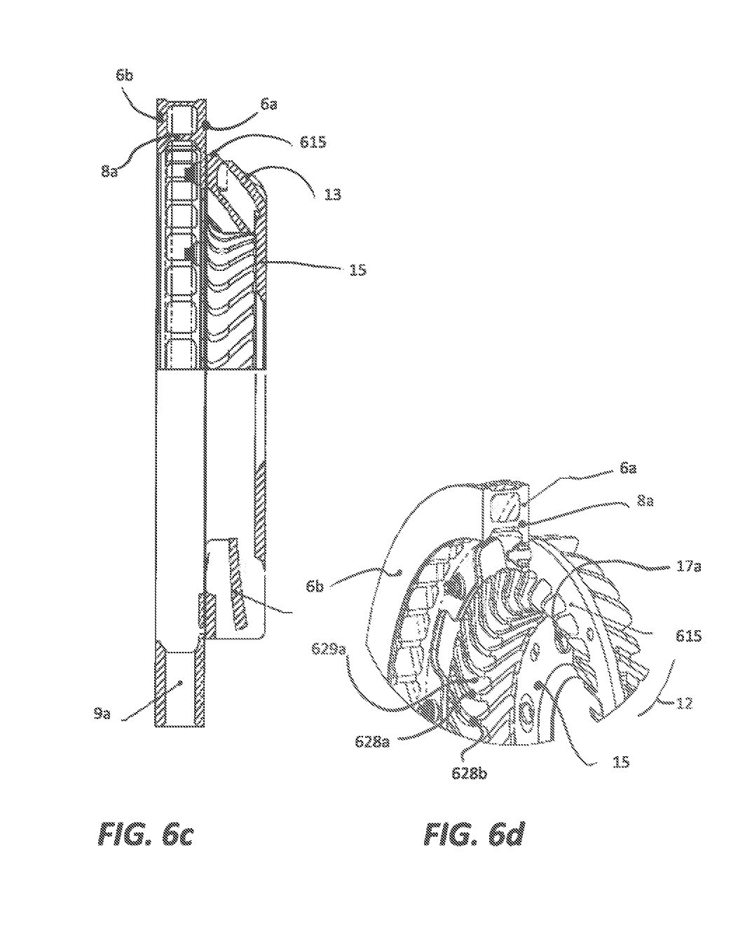

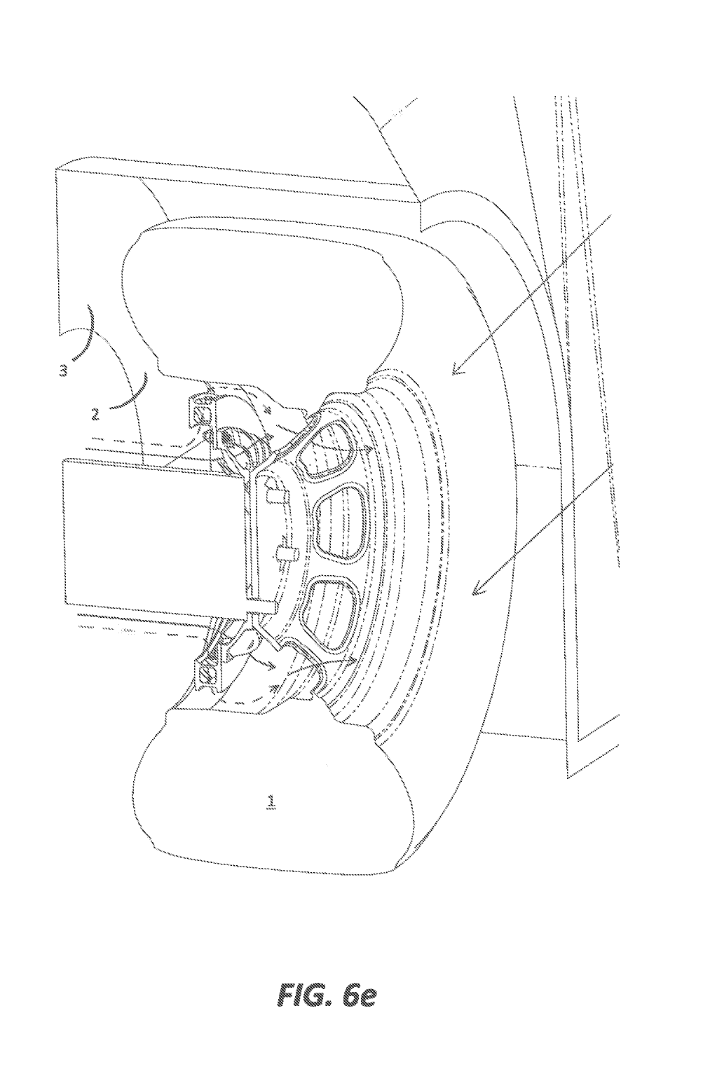

FIG. 6a is a perspective view of the disc assembly of a fifth embodiment;

FIG. 6b is a front elevation of the disc assembly of the fifth embodiment, looking into the mounting bell thereof;

FIG. 6c is a sectional end elevation of the disc assembly of the fifth embodiment, along line A-A of FIG. 6b;

FIG. 6d is a partial sectional perspective view of the disc assembly of the fifth embodiment, along line A-A of FIG. 6b; and

FIG. 6e is a perspective sectional view of the disc assembly of the fifth embodiment looking rearwardly of a car, showing the disc brake in situ mounted to a wheel within the underbody of the car, with the ventilated airflow shown.

### PRIOR ART

Referring to FIG. 1a, a disc brake system for a racing car comprises a disc 2 and a caliper 4 mounted rigidly to the vehicle body and passing round the outer edge of the disc 2. The caliper may be as described in our earlier application EP2022999, incorporated herein by reference. One or more hydraulic pistons (not shown) are mounted within the caliper 4, actuable to move axially inwards (i.e. normal to the surface of the disc 2, parallel to the axle on which it is mounted), from a disengaged position into frictional contact with a peripheral band 10 on the disc 2 when the brakes are actuated.

The disc 2 comprises a pair of parallel coaxial annular plates 6a, 6b between which is an air gap. In the airgap are a plurality of vanes 8a, 8b, . . . running between, and spacing apart, the plates 6a, 6b. The vanes are not radial but inclined at an angle to the radius, so as to define outwardly-flaring, swept-back passages 9a, 9b . . . (visible in FIG. 2b for example), which may also be curved as shown, resembling and operating like those of a cross-flow fan (for which see U.S. Pat. No. 507,445, Mortier). The vanes 8a, 8b may have an involute shape or may simply be linear. They may be discontinuous, or may include gaps, along their lengths. The prior art contains examples of different patterns of vanes which may be used.

A bell mount component 12 sits on the wheel side of the disc 2 as shown in FIG. 1c. It comprises a frustoconical wall 13 flaring from an inner disc 15 to an outer flange 16, mounted to the plates 6a, 6b by bolts 18a, 18b, . . . running through aligned holes (not visible in the drawings) in the flange 16 and the plate 6a.

The disc brake sits on the inward side of the vehicle wheel 1, within a close-fitting wheel arch 3. In use, when the wheel is turning in the correct direction, the vanes 8 operate to draw air from the underside of the car into the passages 9 via the open central region radially inwards of the plates 6a, 6b, and pump it outwards past the braked surfaces 10a, 10b (10b not shown but on the opposite side and facing 10a) of plates 6a, 6b so as to dissipate the heat produced there by friction whilst braking.

The inner disc 15 contains holes 17a, 17b . . . through which run bolts 14a, 14b . . . by which the brake is mountable to the stub axle of the vehicle (not shown) and the wheel 1. The inner disc 15 may have a central hole 19 as shown, lying within the bolts 14, to reduce weight.

The plates 6a, 6b are load-bearing components which must resist torsional loads, and are made of a metal such as cast iron. To reduce weight, the plates 6a, 6b are cut away around the bolts 18a, 18b . . . , to leave radially running lugs or tabs 11a, 11b, . . . through which the bolts 18a, 18b . . . extend axially.

### First Embodiment

A first embodiment of the invention will now be illustrated with reference to FIG. 2, in which like reference numerals refer to equivalent components to those of FIGS. 1a and 1b. In this embodiment, as in the disc brake shown in FIGS. 1a and 1b, the bell mount is made separate of the disc brake 2 and assembled thereto by bolts 18a, 18b, . . . . Both are of known shape. It is desirable to leave access to the bolts. Thus, it is inconvenient for the ventilating vanes 8a, 8b to extend radially inwards of the bolts 18a, 18b.

In this embodiment, a separate extension ventilating ring 200 is provided. After the disc 2 has been bolted to the bell mount 12, the extension ventilating ring 200 is assembled to the disc 2 by a plurality of clips 202a, 202b arranged radially around the ring 200 and clipping into the passages 9a, 9b.

Referring to FIGS. 2b-2d, the extension ventilating ring 200 has the same general structure as the disc 2 and functions to extend the disc 2 inwards. More specifically, it comprises first and second parallel coaxial spaced apart annular walls or rings 206a, 206b the innerwards surfaces of which, when assembled, align with those of the plates 6a, 6b so that the air gap between the rings 206a, 206b is contiguous with that between the plates 6a, 6b. A plurality of extension vanes 208a, 208b running between and spacing apart the rings 206a, 206b, . . . are each respectively aligned with the vanes 8a, 8b, . . . of the plates 6a, 6b so that together they define elongated ventilation slots 209a, 9a; 209b, 9b; . . . running radially outwards.

Providing effectively longer vanes and therefore longer ventilation slots acts to reduce the pressure throughout the ventilation slots due to the increase in swept depth. This reduction in pressure increases the mass flow, making the structure a more efficient pump, which acts to blow more air into the airgap between the plates 6a, 6b, improving the cooling efficiency of the brake. The ventilation air path is shown in FIG. 2e by the arrowed line passing from the inside of the underbody of the car, through the brake disc, outwards through holes in the vehicle rim, and then backwards towards the rear of the car due to its forward motion. The straight diagonal arrowed lines show the airflow leaving the bodywork of the car and crossing the face of the wheel 1, where it will mingle with the airflow from the above-mentioned ventilation path.

The extension ventilating ring 200 is not a load-bearing structure (since the torsional braking load is carried between the axle to the mount 12, then through the bolts 18 to the discs 6a, 6b to the pistons and the caliper 4, and thence to the vehicle body). It can therefore be made thinner, and of a relatively lighter material, than the discs 6a, 6b. For example it may be an aluminium casting. The ring 200 is a separate component which is not in ideal contact with the plates, and may also be of a material with a lower thermal conductivity than the metal plates.

The retaining clips 202a, 202b (or other fixings) need only be strong enough to resist the force applied by the intaken ventilation air running between the vanes 8a, 8b and momentum of the extension ventilating ring, and can therefore also be of lightweight construction. If the same material is used for the extension ring 200, the walls and vanes may be made thinner than their equivalents in the disc 2, thus reducing the weight. The extension ring 200 can have a lower density for the same vane and wall cross-sectional profile as that of the disc 2, again reducing the weight.

Thus, comparing this embodiment to the prior art brake shown in FIG. 1, increased cooling can be provided with minimal additional weight, permitting harder braking and increasing mechanical reliability.

It is possible to apply this embodiment to either the two-part disc-and-bell mount assembly shown, or to a single-part assembly. In either case, the extension ventilating ring 200 of this embodiment may be used with existing disc brake systems, so as to increase the ventilation thereof, with little or no modification to the mounting bell and disc.

It would notionally be possible to achieve the same increase in air flow by extending the plates of the prior art brake of FIG. 1 inwardly, to lengthen the air gaps 9a, 9b. However, as indicated above, this would increase the weight and therefore reduce the vehicle performance, which is undesirable in vehicles such as racing cars or aeroplanes.

Additionally, however, the effect of doing so would be that the radially inner portions of the plates 6a, 6b would be colder, as compared to the braked region 10. Having a relatively cold inside zone on the plates 6a, 6b increases the thermal shock between that zone and the braked region 10, increasing the likelihood of disc cracks, which could lead to mechanical failure with serious consequences for vehicle safety. As compared to such a notional modification of the prior art, the present embodiment therefore provides a lighter, more reliable and safer brake structure.

The effectiveness of a ventilated disc is based on the volume of air being pumped through the disc. The disc vane volume is crucial to this, with each disc having a maximum air pumping efficiency depending on the geometry of the vanes and the separation between the plates 6a, 6b. It will be apparent that the extension ring cannot be extended all the way towards the centre of the disc. When it is attempted to pump too much air through the disc, a back pressure/blockage of air occurs, limiting its performance from improving further. Thus, if the ring extended beyond a certain distance towards the centre, the intake of air does not rise further.

For the illustrated brake disc, it is found that the optimal disc has proportions of approximately Outside Diameter/Inside Diameter=1.414 or, more generally, 1.3-1.5. Thus, where the extension ventilating ring 200 of the present embodiment is used, the relevant ratio is that of the outer diameter of the disc 2 to the inner diameter of the ring 200. However, the optimum disc depth is affected by the vane form (vane angle, vane gap, vane thickness etc), and will vary also based on other characteristics such as upright size, wheel spindle and surrounding parts etc.

### Second Embodiment

Referring to FIGS. 3a-3d, in this embodiment, the extension ring 200 is absent. The disc 2 has the same construction as that of the first (and of the prior art). As in the first embodiment, the mount 12 comprises a mounting plate 15 coaxial with, parallel to and spaced from the disc 2, from which a frustoconical wall 13 flares towards the disc 2.

Between the frustoconical wall 13 and the disc 2 is a ventilator structure comprising upper and lower annular walls 313, 315 coaxial with, parallel to and spaced from the disc 2, and wall 15, running between which are a ring of vanes 328a, 328b, defining between them channels 329a, 329b, . . . . The vanes 328 collectively provide sufficient strength and rigidity to maintain the brake disc 2 in its position, and function collectively as part of the sidewall of the bell mount12.

The vanes 328a, 328b are, like the vanes 8a, 8b, inclined at an angle between radial and tangential to the side wall 315, and the channels 329a, 329b, like the channels 9a, 9b, flare outwardly so that the side of the mounting bell 12 functions as a crossflow fan, blowing air from the interior of the mounting bell 12 to the exterior. Accordingly, it blows air towards the outboard half of the caliper 4, and the outer face of the outboard disc 6a.

The airflow through the channels 9a, 9b between the plates 6a, 6b is not significantly affected, so the airflow through the channels 329a, 329b in the mounting bell 12 is additional to it, and may give of the order of 100% more air mass flow.

The vanes 328 and walls 13, 15, 313, 315 are formed as a single metal casting.

This embodiment may substitute for the use of ducting over or within the caliper bridge, but is preferably used in addition. In fact, larger ducts may be used, as the extra air can now be utilised.

### Third Embodiment

Referring to FIGS. 4a-4d, in this embodiment, the mount 12 is in the form of a stubby cylinder, and accordingly the frustoconical wall 13 is replaced by a cylindrical ring 413 of vanes 428a, 428b . . . joining the mounting plate 15, and defining between them channels 429a, 429b . . . . The vanes 428 are structural components which are sufficiently strong to resist the braking forces acting on the bell mount 12. They join an upper wall 415 which runs coaxial with, parallel to and spaced from the disc 2, and wall 15. They extend further radially inwards than those of the previous embodiment, standing out from the upper wall 415 to increase the volume of blown air, though at a small cost in additional weight.

The vanes 428a, 428b are, like the vanes 8a, 8b, inclined at an angle between radial and tangential to the side wall 415, and the channels 429a, 429b, like the channels 9a, 9b, flare outwardly so that the sidewall of the mounting bell 12 functions as a crossflow fan, blowing air from the interior of the mounting bell 12 to the exterior. Accordingly, it blows air towards the outboard half of the caliper 4, and the outer face of the outboard disc 6b. The ventilation air path is shown in FIG. 4e by the arrowed lines. The dashed arrowed line shows the air path passing from the inside of the underbody of the car through the brake disc, and joining the solid line which shows the path of air passing through the vanes of the bell mount, to flow outwards through holes in the vehicle rim and backwards towards the rear of the car due to its forward motion.

The channels 429a, 429b, . . . are axially wider at their radially outer end than at their radially inner end. The air entering the channels therefore expands axially as well as radially, increasing the efficiency of the pumping action. In other respects this embodiment performs like the second.

### Fourth Embodiment

In this embodiment, referring to FIGS. 5a-5d, it will be seen that features of the first and second embodiments are combined. The mount 12 has a frustoconical wall 13, spaced from the disc 2 by a ring of vanes 528a, 528b, . . . defining passages 529a, 529b, . . . . An extension ring 200 contains a ring of vanes 208a, 208b, . . . as in the first embodiment, defining channels 209a, 209b aligned with those 9a, 9b of the disc 2. A frustoconical wall or ring 515 interconnects the axially inner edges of the extension ring vanes 208a, 208b, . . . and the axially inner edges of the mounting vanes 528a, 528b, . . . . The wall 515 flares in the opposite direction to the wall 15. The result is that the vanes 208 become axially wider as they extend radially outwards, and the vanes 528 become axially narrower as they extend radially outwards.

The vanes 208 and 528, and walls 206b, 515 may be provided as a single unit, bolted between the disc 2 and mount 12.

Thus, the airflow into the interior of the disc 2 is improved at the same time as that over the caliper and outside of the outboard plate of the disc 2. As mentioned above, these benefits are cumulative. That is, the additional airflow produced by a well-designed extension ring 200 is supplemented by that produced by the vanes in the mounting bell.

### Fifth Embodiment

Referring to FIGS. 6a-6e, this embodiment is similar to the third, except for the shape of the vanes and the resulting airflow. Like parts will therefore not be discussed further.

In previous embodiments, the vanes of the bell have been curved or inclined in a plane parallel to that of the disc brake 2, but oriented essentially transverse to the disc, so that the sidewall of the mounting bell 12 functions as a crossflow fan, blowing air . The effect was therefore to direct air substantially radially outwards of the bell, towards the caliper 4. In this embodiment, the ring 613 of vanes 628a, 628b (and hence the channels 629a, 629b . . . defined between them) are attached to an annular ring 615, and are inclined or curved both in the plane of the disc 2 (and the annular ring 615) and also transverse to that plane, so that the air sucked from beneath the vehicle moves not only radially, but also axially, of the disc 2 and mounting bell 12, away from the disc 2 and towards the spokes of the wheel 1 as shown in FIG. 6e.

The ventilation air path is shown in FIG. 6e by the arrowed lines. The dashed arrowed line shows the air path passing from the inside of the underbody of the car through the brake disc, and joining the solid dashed line which shows the path of air passing through the vanes of the bell mount, to flow outwards through holes in the vehicle rim and backwards towards the rear of the car due to its forward motion. In other respects this embodiment performs like the third.

Generally, in the above embodiments, air flows into the car underbody from the front and sides of the car, where it accelerates and therefore reduces pressure. When this invention is used without brake ducts, it can pull air from the underbody radially outwards through or over the brake discs, and/or axially through the holes (or between the spokes) of the vehicle rim.

The air is then pumped out through the wheel to the rear of the car. This further reduces the underbody air pressure, increases the downward force on the car and therefore makes the whole underbody more efficient, which is of particular benefit for high-performance cars (particularly racing cars, more particularly those for Formula 1), operating at high speeds with the underbody low to the ground. The present invention could also be employed in cars with brake ducts, if the duct inlet is positioned under the car rather than, as in the prior art, in a high-pressure air region. The benefits of cooling, on the one hand, and aerodynamic downforce, on the other, can be balanced by shaping the vanes of the bell to vary respectively the axial and radial components of the air path leaving the mounting bell.

Whilst the present inventors have now realised that some limited benefit of this kind might occur with even a conventional vented disc brake (if not provided with brake ducts), the present invention substantially increases any such aerodynamic effects. Whilst it is preferred that all wheels of a vehicle are provided with such brakes, it would be possible to gain some advantage by providing such brakes on one or more wheels, typically for all wheels on the same axle.

### Other Embodiments and Modifications

It will be clear that details described above may be varied by the skilled reader. Whilst the invention is particularly applicable to racing cars, where thermal and mechanical stresses are high and weight is at a premium, it might also be advantageously employed in any other type of disc brake.

The disc 2 and mount 12 may be made in any convenient fashion. Whilst bolted constructions have been described, the invention is also applicable to brakes in which the mount 12 is cast or otherwise integrally formed with the disc 2. The mount may have any convenient or conventional shape such as a stubby cylinder, cone, dome or bell. Whilst bolt mountings between the disc and the bell have been described, the invention is also applicable to brake systems in which the two are otherwise connected, for example by a bobbin drive, a gear drive or a spline drive to allow the disc to expand relative to the bell. Examples of such mountings are the “Float in the bell” bobbin mounts sold by the present applicant,

Whilst iron brake discs have been described, other high temperature-resistant materials could be used; for example, carbon fibre bands on iron discs, carbon-carbon discs, sheet steel discs or carbon in ceramic discs.

Whilst various shapes having rotational symmetry have been described and are preferred, it will be apparent that only the friction region 10 (and the outermost edge of the disc 2) must actually be circular.

The ventilating structures described herein as rings need not be a complete ring—although this is preferred, providing ventilation in a part of a ring will nonetheless provide at least some benefits.

In the first embodiment, instead of spring clips 202, a snap-in structure may be used. All the vanes provided in each embodiment can be curved rather than straight. Whilst it is preferred to provide that the vanes 208 etc are aligned with the disc brake vanes 8, they need not be in alignment provided that they communicate so that air can pass between them.

In the first embodiment, the disc brake itself could be an unmodified existing brake, to which the extension ring 200 is retrofitted, but it may be more convenient to make minor modifications to the brake disc to accommodate the extension ring.

The features of the various embodiments may be freely combined, whether or not so stated above. In particular, the first and third embodiments can be combined. Many other variants and embodiments will be apparent to the skilled reader, all of which are intended to fall within the scope of the invention whether or not covered by the claims as filed. Protection is sought for any and all novel subject matter and combinations thereof disclosed herein.

1. A ventilated disc brake comprising:
a friction portion,
a mounting portion, and
an axially inner portion, said axially inner portion comprising an axially inner ventilating
structure being separate of said friction portion and having:
a thinner cross section,
a lower density, and/or
a lower thermal conductivity,
than said friction portion.

2. A brake according to claim 1, wherein said friction portion comprises first and second coaxial, parallel annular friction surfaces having ventilation channels running there between aligned at an angle between radial and tangential of said disc so as to pass air outwards from the axially inner ventilating structure, and the axially inner ventilating structure has a plurality of extension channels communicating with said ventilation channels.

3. A brake according to claim 2, wherein said extension channels are aligned with said ventilation channels.

4. A brake according to any preceding claim, wherein said axially inner structure comprises a hollow annular ring coaxial with said friction surfaces.

5. A brake according to any preceding claim, wherein said axially inner ventilating structure is secured to said friction portion by at least one fastener.

6. A brake according to any preceding claim, wherein said friction portion is metallic.

7. A brake according to claim 6, wherein said friction portion is formed of cast iron.

8. A brake according to any preceding claim, wherein said axially inner ventilating structure is not load-bearing.

9. A brake according to claim 8, wherein said axially inner ventilating structure is separate of, and has:
a thinner cross section,
a lower density, and/or
a lower thermal conductivity, than
said friction portion.

10. A brake according to any preceding claim, in which the ratio of the outer diameter of the disc to the inner diameter of said ventilating structure is approximately 1.3-1.5.

11. A method of increasing the ventilation provided by a ventilated disc brake comprising a friction portion and a mounting portion defining an internal cavity, by fastening therein an axially inner ventilating structure separate of said friction portion and having:
a thinner cross section,
a lower density, and/or
a lower thermal conductivity,
than said friction portion.

12. An axially inner ventilating structure shaped to fit to a ventilated disc brake with a bell mount.

13. A disc brake comprising a friction portion and a mounting structure, said mounting structure comprising a mounting surface securable to rotate with a wheel, said mounting surface being coaxial with and axially displaced from the friction portion, the mounting structure further comprising a ventilator arranged to direct air outwardly from the interior of the mounting structure.

14. A brake according to claim 13, in which said mounting structure comprises a plurality of radially distributed apertures.

15. A brake according to claim 14, in which said mounting structure comprises a wall having the general form of a surface of rotation.

16. A brake according to claim 15, in which said wall is approximately cylindrical.

17. A brake according to claim 15, in which said wall is approximately frustoconical.

18. A brake according to claim 15, in which said wall is domed.

19. A brake according to any of claims 13 to 18, in which said ventilator comprises a plurality of vanes aligned at an angle between radial and tangential of said mounting surface so as to pass air in directions having a component lying radially outwards thereof.

20. A brake system comprising a brake according to any of claims 13 to 19 and a caliper mounted around the disc thereof, the ventilator being arranged to direct air towards the caliper.

21. A brake system comprising a brake according to any of claims 13 to 20 in which said ventilator comprises a plurality of vanes aligned or curved at an angle in a plane parallel to said mounting surface so as to pass air in directions having a component lying axially outwards thereof and towards said wheel.

22. A vehicle comprising a vehicle body, and a brake system according to any preceding claim associated with at least one wheel thereof, so as in use to pump air from underneath the body rearwardly of said wheel.

23. A vehicle according to claim 21 in which the or each said at least one wheel are mounted in the body without an associated brake duct.

24. A vehicle according to claim 22 or 23 in which said vehicle is a racing car.
